(19) United States
(12) Patent Application Publication
(10) Pub. No.: US 2026/0031267 A1
(43) Pub. Date: Jan. 29, 2026

(54) COIL COMPONENT

(71) Applicant: TAIYO YUDEN CO., LTD., Tokyo (JP)

(72) Inventors: Takayuki ARAI, Tokyo (JP); Tomoo KASHIWA, Tokyo (JP)

(21) Appl. No.: 19/262,588

(22) Filed: Jul. 8, 2025

(30) Foreign Application Priority Data
Jul. 25, 2024 (JP) 2024-119653

(51) Int. Cl. H01F 27/29; H01F 27/255

(52) U.S. Cl. CPC H01F 27/292; H01F 27/255

(57) ABSTRACT

A coil component includes a base body made of a magnetic material; two external electrodes respectively provided on surfaces of the base body that are facing each other; and a conductor connected to each of the two external electrodes and directed from one of the external electrodes to another one of the external electrodes in the base body. The conductor includes a protruding portion on a surface in contact with the base body.

### CROSS-REFERENCE TO RELATED APPLICATIONS

This patent application is based on and claims priority to Japanese Patent Application No. 2024-119653 filed on Jul. 25, 2024, the entire contents of which are incorporated herein by reference.

### TECHNICAL FIELD

The present disclosure relates to a coil component, particularly a coil component having a plurality of inductor elements and used to be built into a substrate.

### BACKGROUND

As described in Patent Document 1, a known coil component includes a chip body (base body) made of a magnetic material, a conductor embedded in the chip body so as to be exposed from both end surfaces of the chip body, which are opposite surfaces of the chip body, and a pair of external electrodes electrically connected to the exposed portions of the conductor. In the configuration described in Patent Document 1, the conductor is arranged so as to be directed from one of the opposing external electrodes to the other.

Also known is a component-embedded substrate, in which electronic components such as coil components are embedded in the substrate. By embedding a plurality of coil components in the substrate, electronic components such as coil components can be mounted at high density.

In the component-embedded substrate, the external electrodes of the electronic components such as coil components are electrically connected to the wiring through via conductors. The via conductors are formed by sealing, with resin, the coil components mounted in a cavity formed in an insulating layer of a printed-circuit board, irradiating, with a laser, the external electrodes of the coil components sealed with the resin, to form via holes and expose the external electrodes, and applying plating treatment to the via holes.

### RELATED ART DOCUMENT

### Patent Document

Patent Document 1: Japanese Laid-open Patent Application Publication No. H10-144526

### SUMMARY

An embodiment of the present disclosure is a coil component including a base body made of a magnetic material; two external electrodes respectively provided on surfaces of the base body that are facing each other; and a conductor connected to each of the two external electrodes and directed from one of the external electrodes to another one of the external electrodes in the base body. The conductor includes a protruding portion on a surface in contact with the base body.

### BRIEF DESCRIPTION OF THE DRAWINGS

FIG. 1 is a perspective view of a coil component according to the first embodiment;

FIG. 2 is a partial enlarged view of a cross-section at the I-I line of FIG. 1;

FIG. 3 is an enlarged view of a part II of FIG. 2;

FIG. 4 is a cross-sectional view of a conductor along the line III-III of FIG. 3;

FIG. 5 is a diagram for explaining the preferred height of the protruding portion;

FIG. 6 is a partial enlarged view of the cross-section at the line I-I of FIG. 1 of a coil component according to a second embodiment;

FIG. 7 is an enlarged view of a part IV in FIG. 6;

FIG. 8 is a cross-sectional view along line V-V in FIG. 7;

FIG. 9 is a partial cross-sectional view along the Y-Z plane of a coil component according to a modified example;

FIGS. 10A and 10B are partial cross-sectional views of a coil component along the X-Y plane according to a modified example;

FIG. 11 is a cross-sectional view along the thickness direction of a substrate with a built-in component including a coil component;

FIGS. 12A to 12F are diagrams for explaining a method of manufacturing a coil component by a lamination process; and

FIG. 13A and FIG. 13B are diagrams for explaining a method of manufacturing a coil component by a lamination process.

### DETAILED DESCRIPTION

When a coil component is exposed to a temperature change, the conductor can thermally expand or thermally contract more than the base body because of the difference in the coefficient of thermal expansion between the conductor and the base body. Because the base body has high rigidity, thermal expansion or thermal contraction (hereinafter, also referred to as thermal deformation) in the portion of the conductor surrounded by the base body is reduced by the presence of the base body. However, because the end of the conductor is exposed from the surface of the base body such that the function to reduce thermal deformation by the base body does not work, thermal expansion or thermal contraction tends to occur. Therefore, damage such as cracks may occur near the end of the conductor, or in the external electrode connected to the conductor, or in the wiring connected to the external electrode.

In particular, when a base body composed of metallic magnetic material particles made of soft magnetic material is used, magnetic saturation is less likely to occur than a base body composed of ferrite, and has high superposition characteristics, and is used in circuits in which a large current flows. Therefore, the amount of heat generated by applying the current is also large.

As described in Patent Document 1, when the conductor is arranged so as to be directed from one of the opposing external electrodes to the other, the function of reducing thermal deformation by the base body becomes difficult to work in the opposing direction, and therefore, thermal expansion or thermal contraction of the conductor is more likely to occur.

Therefore, the possibility of occurrence of damage due to thermal deformation of the conductor increases in an environment with temperature change. In particular, in the case of a coil component incorporated in a component-embedded substrate, because the coil component is easily affected by heat from other elements in the substrate, the above-mentioned problem of thermal deformation is likely to occur.

According to an embodiment of the present disclosure, it is possible to provide a coil component capable of reducing thermal deformation of a conductor caused by temperature change and preventing damage caused by thermal deformation.

Embodiments of the present disclosure will be described in detail below, but the present disclosure is not limited thereto. In the present specification and the drawings, components having substantially the same functional configuration may be denoted by the same reference numerals so that duplicate descriptions are omitted. Each of the drawings is a schematic diagram illustrated for the purpose of clarifying the description of the present disclosure, and is not necessarily illustrated on an accurate scale. In the drawings, the mutually orthogonal X-axis, Y-axis, and Z-axis are illustrated as axes defining a fixed coordinate system for the coil component. In the present specification, the extending direction of the X-axis is referred to as the X-direction, the extending direction of the Y-axis is referred to as the Y-direction, and the extending direction of the Z-axis is referred to as the Z-direction.

### First Embodiment

### (Basic Structure of the Coil Component)

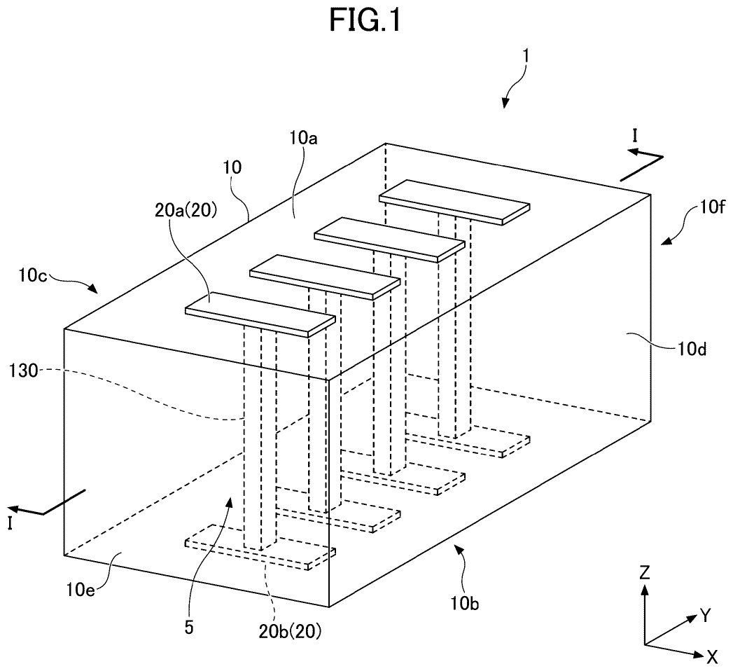

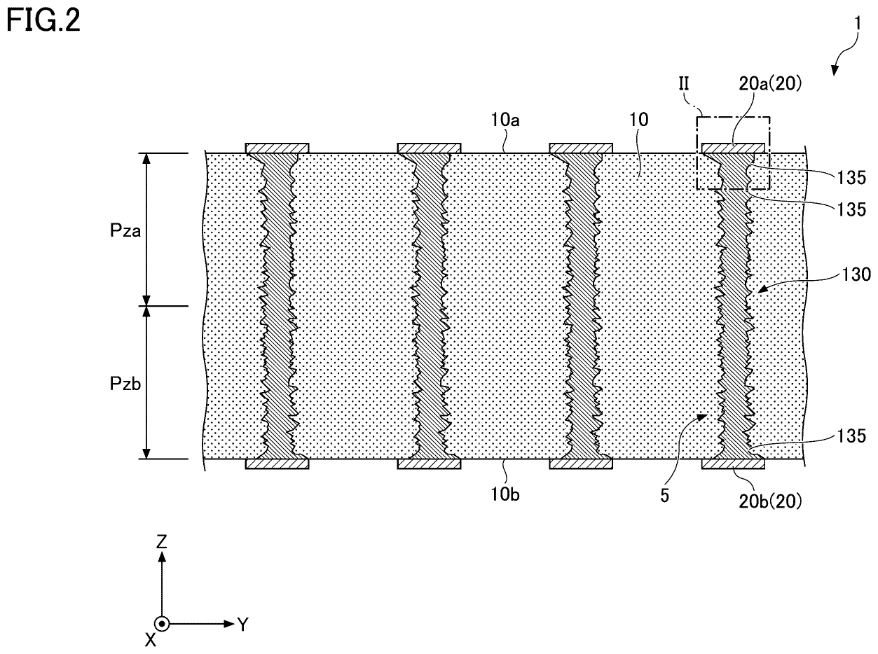

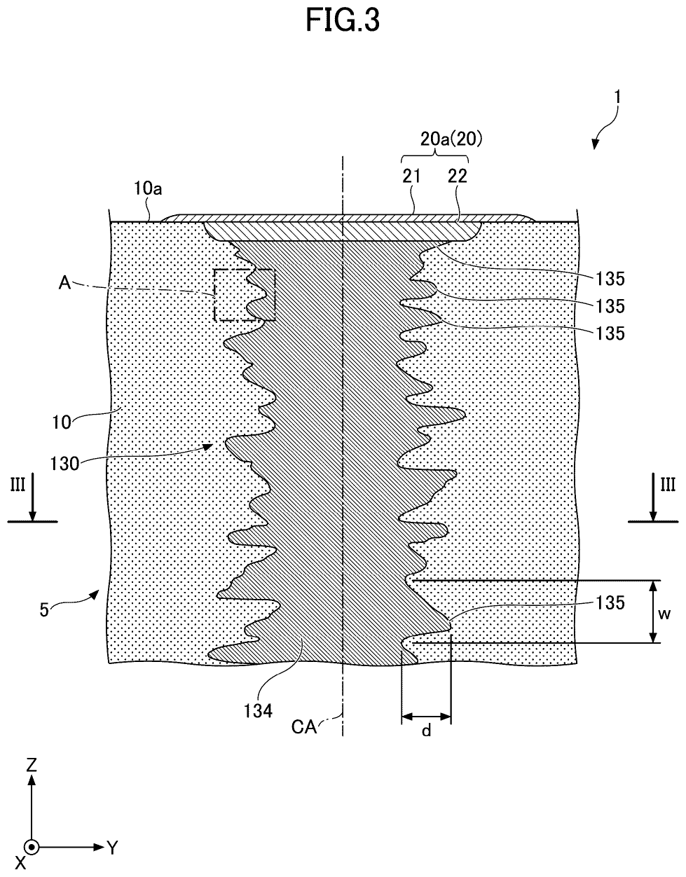

First, the basic structure of the coil component 1 of the present disclosure will be described. FIG. 1 is a perspective view of the coil component 1 according to the first embodiment. FIG. 2 is a partial enlarged view of the cross-section of the I-I line of FIG. 1. FIG. 3 is an enlarged view of the portion II of FIG. 2. FIG. 1 also serves as a perspective view of the second embodiment described below.

The coil component illustrated in FIGS. 1 to 3 is suitably used as an inductor component. The coil component is used in a wiring substrate having built-in components. Further, the wiring substrate in which a coil component 1 of the present embodiment is mounted is suitably used in electronic devices such as smartphones, tablets, game consoles, servers, and electric components of automobiles.

As illustrated in FIGS. 1 and 2, the coil component 1 has a base body 10, a pair of external electrodes 20 provided on mutually opposite surfaces of the base body 10, and a conductor 130 connected to each of the two external electrodes 20 and extending inside the base body 10. One inductor element 5 is formed by the base body 10, the pair of external electrodes 20, and one conductor 130. In the example illustrated in FIGS. 1 and 2, the coil component 1 is provided with four conductors 130, and these conductors are electrically independent. The coil component 1 is an array-type inductor component (inductor array) in which four inductor elements 5 each including a conductor 130 are formed. However, the number of inductor elements included in the coil component according to the embodiment of the present disclosure is not limited to four. That is, the coil component 1 may include one inductor element or a plurality of inductor elements other than four. The inclusion of a plurality of inductor elements in the coil component makes it possible to mount a plurality of inductor elements simultaneously by a single operation of mounting one coil component, which is preferable in that the mounting operation is not complicated. Further, because the relative position adjustment of the plurality of inductor elements is not required, the reliability of the wiring substrate in which the coil component is mounted and incorporated can be improved.

In the example illustrated in FIG. 1, the four inductor elements 5 are arranged in a row in the Y-direction, but when the coil component 1 includes a plurality of inductor elements 5, the plurality of inductor elements 5 may be arranged in a two-dimensional manner. That is, a plurality of element rows, each row including a plurality of inductor elements 5 arranged in one direction, may be arranged in a direction orthogonal to the one direction.

As illustrated in FIG. 1, the base body 10 may have a substantially rectangular parallelepiped shape. The base body 10 may have 6 surfaces defining its outer surface, specifically, a first main surface 10a, a second main surface 10b, a first side surface 10c, a second side surface 10d, a first end surface 10e, and a second end surface 10f. The first main surface 10a and the second main surface 10b face each other, the first side surface 10c and the second side surface 10d face each other, and the first end surface 10e and the second end surface 10f face each other. The areas of the first main surface 10a and the second main surface 10b are larger than the areas of the first side surface 10c, the second side surface 10d, the first end surface 10e, and the second end surface 10f. When the coil component 1 is provided on a substrate to constitute a wiring substrate, the coil component 1 is arranged such that the surface direction along the first main surface 10a or the second main surface 10b (the direction along the X-Y plane) is along the surface direction of the substrate.

As illustrated in FIGS. 1 and 2, the direction in which the first main surface 10a and the second main surface 10b face each other (opposing direction of the main surfaces 10a, 10b) is the Z-direction. The direction in which the first side surface 10c and the second side surface 10d face each other (opposing direction of the side surfaces 10c, 10d) is the X-direction, and the direction in which the first end surface 10e and the second end surface 10f face each other (opposing direction of the end surfaces 10e, 10f) is the Y-direction. In FIGS. 1 and 2, because the first main surface 10a is located on the upper side of the base body 10, the first main surface 10a may be referred to as the “upper surface” and the second main surface 10b may be referred to as the “lower surface”. The vertical direction of the base body 10 is also referred to as the height direction and is defined as the Z-direction in the drawing. The longitudinal direction of the base body 10 is also referred to as the length direction and is defined as the Y-direction in the drawing. Further, the direction orthogonal to both the height direction (Z-direction) and the length direction (Y-direction) is also referred to as the width direction, and is defined as the X-direction in the drawing.

In FIG. 1, each of the surfaces 10a to 10f of the base body 10 is illustrated as a plane, but each of the surfaces 10a to 10f may be curved. Although each of the surfaces 10a to 10f is illustrated to be orthogonal to the adjacent surface, each of the surfaces 10a to 10f need not necessarily be orthogonal to the adjacent surface. Further, each vertex of the base body 10 may be rounded, and the ridge line of the base body 10 (the line indicating the boundary between the adjacent surfaces of each of the surfaces 10a to 10f) need not be straight, but may be curved according to the shape and arrangement of each of the surfaces 10a to 10f.

The height of the base body 10, that is, the distance between the first main surface 10a and the second main surface 10b facing each other (the dimension of the Z-direction) may be 0.5 mm or more and 2 mm or less. The width of the base body 10, that is, the distance between the first side surface 10c and the second side surface 10d facing each other (the dimension of the X-direction) may be 0.5 mm or more and 10 mm or less. The length of the base body 10, that is, the distance between the first end surface 10e and the second end surface 10f facing each other (the dimension of the Y-direction) may be 2 mm or more and 20 mm or less. The dimension of the Z-direction of the base body 10 may be smaller than the dimension of the X-direction and the dimension of the Y-direction. The dimension of the coil component 1 is the dimension in which the external electrode 20 is added to the base body 10, and is approximately equal to the dimension of the base body 10 that is described above.

The base body 10 is made of a magnetic material, and more specifically, includes metal magnetic particles. Further, the base body 10 may be a composite magnetic material including metal magnetic particles and a binder, that is, a metal composite. The base body 10 made of a metal composite is obtained, for example, by pressure-molding a slurry obtained by kneading a composite magnetic material including metal magnetic particles and a binder made of resin (also referred to as a resin binder).

The metal magnetic particles included in the base body 10 may be a mixture of one or more kinds of metal magnetic particles. The metal magnetic particles included in the base body 10 may include one or more kinds of iron (Fe), nickel (Ni), and cobalt (Co). Specific examples of the materials constituting the metal particles include Fe, Fe—Ni alloy, Fe—Co alloy, Fe—Si alloy, Fe—Si—Al alloy, Fe—Si—Cr alloy, Fe—Si—Al—Cr alloy, Fe—Si—Cr—B alloy, Fe—Si—Cr—B—C, and the like. These metallic magnetic particles can be used alone or as mixed particles by mixing two or more kinds.

The cross-sectional shape of the metal magnetic particles may be circular, elliptical, or a shape modified from these. The average particle size of the metal magnetic particles contained in the base body 10 may preferably be 1 μm or more and 20 μm or less, more preferably 2 μm or more and 10 μm or less. The average particle size of the particles in the present specification may be an average particle size (median size (D50)) calculated from a volume-based particle size distribution measured based on a scanning electron microscope (SEM) image.

The binder contained in the base body 10 may be an organic binder, an inorganic binder, or both. The organic binder is preferably a resin, particularly a thermosetting resin having excellent insulating properties. Specific examples of resin materials for the binder include epoxy resin, polyimide resin, polystyrene (PS) resin, high-density polyethylene (HDPE) resin, polyoxymethylene (POM) resin, polycarbonate (PC) resin, polyvinylidene fluoride (PVDF) resin, phenol resin, polytetrafluoroethylene (PTFE) resin, and polybenzoxazole (PBO) resin. Examples of the inorganic binder are inorganic oxides such as B₂O₃, NaO, SiO₂, ZnO, PbO, and glass. The above binder can be used alone or in a combination of two or more kinds.

The ratio of metallic magnetic particles to the whole base body 10 may be 80 vol % or more. The ratio of the binder to the whole base body 10 may be 3 vol % or more. The base body 10 may contain voids, but the ratio of voids to the whole base body 10 may be less than 2 vol %.

As illustrated in FIGS. 1 and 2, the external electrode 20 includes a first external electrode 20a and a second external electrode 20b which are spaced apart from each other. In the example illustrated in FIGS. 1 and 2, the first external electrode 20a is provided on the first main surface 10a of the base body 10, and the second external electrode 20b is provided on the second main surface 10b of the base body 10. Therefore, the first external electrode 20a and the second external electrode 20b face each other in the opposing direction of the main surfaces 10a and 10b, that is, in the Z-direction. The first external electrode 20a is connected to one end of the conductor 130, and the second external electrode 20b is connected to the other end of the conductor 130.

The external electrodes 20 are provided only on the opposite surfaces of the base body 10 and are connected to the ends of the conductor 130. In the case of FIGS. 1 and 2, the external electrodes 20 are provided on the first main surface 10a and the second main surface 10b of the base body 10.

As illustrated in FIG. 3, each external electrode 20 may include a first portion 21 formed on the outermost side and a second portion 22 arranged inward of the first portion 21 and inward in the Z-direction from the main surface (the first main surface 10a and the second main surface 10b) of the base body 10. If the external electrode 20 is formed to include the first portion 21 and the second portion 22, a sufficient thickness can be secured. The first portion 21 may be formed to cover the second portion 22. Although not illustrated in FIGS. 1 to 3, an insulating layer flush with the second portion 22 may be arranged on the periphery of the second portion 22. The dimensions of the base body 10 and the coil component 1 described above may be the dimensions in the state in which the insulating layer is arranged.

The thickness (length in the Z-direction) of the external electrode 20 may be 15 μm or more and 30 μm or less. When the external electrode 20 includes the first portion 21 and the second portion 22, the thickness is the total thickness of the first portion 21 and the second portion 22. The thickness of the first portion 21 may be 5 μm or more and 20 μm or less. The thickness of the second portion 22 may be 10 μm or more and 30 μm or less.

The external electrode 20 may include silver (Ag), copper (Cu), nickel (Ni), and one or more of these alloys. The first portion 21 and the second portion 22 may be made of the same material or different materials.

As illustrated in FIGS. 1 and 2, the conductor 130 is embedded in the base body 10, and the two ends thereof are respectively arranged so as to be exposed from the first main surface 10a and the second main surface 10b of the base body 10. The two ends of the exposed conductor 130 are connected to the first external electrode 20a and the second external electrode 20b, respectively. In FIG. 1, protruding portions 135 formed on the conductor 130 are not illustrated.

Further, the conductor 130 is arranged so as to be directed from the first external electrode 20a arranged on the first main surface 10a toward the second external electrode 20b arranged on the second main surface 10b, or from the second external electrode 20b arranged on the second main surface 10b toward the first external electrode 20a arranged on the first main surface 10a. That is, the conductor 130 extends along the opposing direction in which the first main surface 10a and the second main surface 10b face each other, that is, the Z-direction, or the conductor 130 is embedded so as to penetrate the base body 10 in the Z-direction. In the present specification, the term “along the predetermined direction” does not only mean that the direction of extension coincides with the predetermined direction, but also means that the direction of extension deviates from the predetermined direction and forms an angle of preferably 100 or less, more preferably 5° or less with respect to the predetermined direction.

In the examples illustrated in FIGS. 1 to 3, the conductor 130 may be arranged linearly in the base body 10. Here, the “linear” arrangement of the conductor means that the center axis CA (FIG. 3) of the conductor is arranged along the opposing direction (Z-direction) in which the first main surface 10a and the second main surface 10b face each other, and preferably, the direction of the center axis CA (FIG. 3) of the conductor is arranged to coincide with the opposing direction (Z-direction). The conductor 130 may include a curved portion or a partially wound portion in the base body 10. When the conductor 130, preferably the entire conductor 130, is arranged linearly, the opposing external electrodes can be connected with the shortest conductor length, and the DC resistance value of the coil component can be reduced.

The conductor 130 may contain silver (Ag), copper (Cu), nickel (Ni), and one or more of these alloys. The conductor 130 may be formed by providing a conductor forming material (conductive paste, etc.) by using plating, screen printing, etc.

### (Concrete Structure of the Conductor)

Next, the conductor 130 according to an embodiment of the present disclosure will be described more specifically. Here, in addition to FIGS. 1 to 3, FIG. 4 illustrates a cross-sectional view along the line III-III of FIG. 3.

As illustrated in FIGS. 2 to 4, the conductor 130 according to the present embodiment has protruding portions 135 formed on the surface in contact with the base body 10. The protruding portion 135 protrudes from the peripheral surface of the core portion 134 of the conductor 130 in a direction orthogonal to the Z-direction, that is, along the X-Y plane. FIGS. 2 and 3 illustrate cross-sections along the Z-Y plane including the central axis CA of the conductor 130. However, even if the cross-section does is not along the Z-Y plane or does not include the central axis CA, it is sufficient if the protruding portion 135 can be confirmed in the conductor 130 when the conductor 130 is viewed as a cross-section cut along any Z-direction. The presence of the protruding portion 135 in the conductor 130 can be confirmed, for example, by observing, with a microscope or the like, any surface of the coil component 1 obtained by cutting the conductor 130 along the Z-direction.

When an electronic device equipped with a coil component is used, the coil component is exposed to temperature changes due to heat generation of elements included in the electronic device. Among the members constituting the coil component, the conductor has a relatively large coefficient of thermal expansion, and, therefore, the conductor is more likely to undergo thermal expansion or thermal contraction (hereinafter, also referred to as thermal deformation) than the base body. Because the rigidity of the base body is high, the above-mentioned thermal deformation of the conductor is reduced in the portion surrounded by the base body, but it is more likely to occur in the portion where the base body is not in contact with the conductor, that is, in the end portion of the conductor exposed from the base body. Further, as illustrated in FIGS. 1 and 2, when the conductor extends along the opposing direction (Z-direction) in which the first main surface 10a and the second main surface 10b of the base body face each other, the effect of reducing the thermal deformation of the conductor in the opposing direction (Z-direction) is weakened in the base body, and, therefore, the amount of thermal deformation in the opposing direction can be large. Therefore, a load is applied to the periphery of the end portion of the conductor 130, for example, the external electrode 20 connected to the conductor 130, and damage such as cracks and separation between members may occur. More specifically, damage may occur to the external electrode 20 connected to the conductor 130, or to the wiring or the like connected to the external electrode 20 when the coil component 1 is incorporated in a substrate.

On the other hand, according to the present embodiment, the peripheral surface of the conductor 130 is not as smooth as in the conventional technology, and has protruding portions 135 on the surface in contact with the base body 10. Because the protruding portions 135 protrude along the direction orthogonal to the opposing direction (Z-direction) and bite into the base body 10, the base body 10 enters the upper or lower side of the protruding portions 135, or both sides thereof (FIG. 3). Thus, the thermal deformation of the conductor 130 can be reduced in the vertical direction (that is, in the opposing direction or the Z-direction) at the position of the protruding portions 135. More specifically, when the base body 10 enters the side close to the main surface (the first main surface 10a and/or the second main surface 10b) of the protruding portions 135 in the Z-direction, the deformation due to thermal expansion of the conductor 130 can be effectively reduced, and when the base body 10 enters the side far from the main surface (the first main surface 10a and/or the second main surface 10b) of the protruding portions 135 in the Z-direction, the deformation due to thermal contraction of the conductor 130 can be effectively reduced. The configuration according to the present embodiment, which exhibits the thermal deformation reducing function due to the protruding portions 135, is particularly suitable for the coil component 1 provided with the conductors 130 (the conductors 130 without curved portions or wound portions) which are arranged linearly where thermal deformation is likely to occur.

The number of the protruding portions 135 formed in one conductor 130 may be one or a plurality, counted along the Z-direction. As illustrated in FIGS. 2 and 3, when a plurality of the protruding portions 135 are formed in one conductor 130 along the Z-direction, the above-described thermal deformation reducing effect of the conductor 130 can be improved. As illustrated in FIGS. 2 and 3, the plurality of the protruding portions 135 need not be arranged regularly along the Z-direction. That is, the pitches of the protruding portions 135 do not necessarily have to be constant.

Here, as illustrated in FIG. 2, the coil component 1 or the base body 10 is divided into two equal parts along the Z-direction to form an upper portion Pza and a lower portion Pzb. When a plurality of protruding portions 135 are formed along the Z-direction, it is preferable that at least one protruding portion 135 is formed in the upper portion Pza and at least one protruding portion 135 is formed in the lower portion Pzb. That is, when the conductor 130 is divided into regions extending over the upper portion Pza and the lower portion Pzb, at least one protruding portion 135 is formed in a section extending over the upper portion Pza of the conductor 130 and at least one protruding portion 135 is formed in a section extending over the lower portion Pzb of the conductor 130. By forming at least one protruding portion 135 in each of the upper portion Pza and the lower portion Pzb, the effect of reducing the thermal deformation of the conductor 130 in the vertical direction (Z-direction) can be improved in each of the upper portion Pza and the lower portion Pzb. As described above, the portions where the conductor 130 is exposed from the base body 10 and where the thermal deformation of the conductor 130 is likely to occur, are on the first main surface 10a side (upper side) and the second main surface 10b side (lower side), so that the external electrode 20 or the wiring connected to the external electrode 20 can be prevented from being damaged in each of these portions.

As described above, because the locations where the thermal deformation of the conductor 130 is likely to occur are the ends of the conductor 130 where the conductor 130 is exposed from the base body 10 and where the deformation reducing function by the base body 10 is unlikely to occur, it is preferable that the protruding portions 135 are formed at a position closer to the ends of the conductor 130. With this configuration, the thermal deformation can be effectively reduced. Therefore, for example, it is preferable that at least one protruding portion 135 is formed on the upper portion of the portion obtained by further bisecting the upper portion Pza, and at least one protruding portion 135 is formed on the lower portion of the portion obtained by further bisecting the lower portion Pzb.

Further, as illustrated in FIGS. 2 and 3, it is preferable that the protruding portion 135 is directly connected to the external electrode 20. That is, it is preferable that the protruding portion 135 is formed at the end of the conductor 130 exposed from the base body 10. Accordingly, the thermal deformation of the conductor 130 can be reduced, especially, the deformation at the time of thermal contraction can be reduced, and damage to the wiring or the like which may occur in the coil component 1 or its vicinity can be prevented.

As illustrated in FIG. 3, the external electrode 20 may be formed to cover the entire conductor 130 including the protruding portion 135. That is, when viewed from the top, that is, when viewed toward the surface of the base body 10 provided with the external electrode 20, the conductor 130 is provided within the range of the external electrode 20. When the external electrode 20 includes the first portion 21 and the second portion 22, it is preferable that both the first portion 21 and the second portion 22 are formed to cover the entire conductor 130.

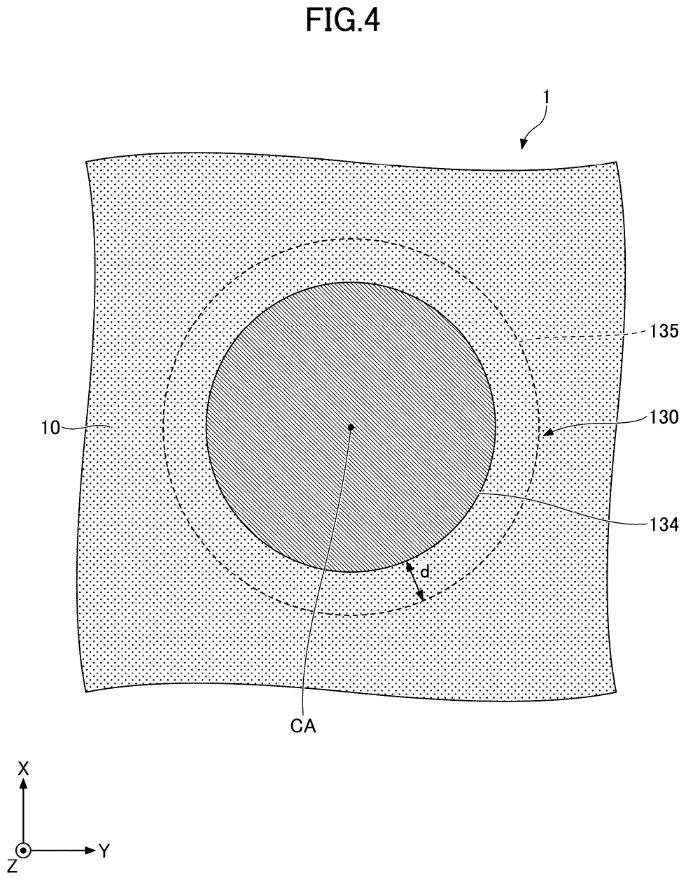

Further, as illustrated in FIG. 4, the protruding portion 135 may be formed on the entire peripheral surface along the periphery of the conductor 130. That is, the protruding portion 135 is a closed annular portion when viewed from a cross-section perpendicular to the Z-direction or along the X-Y plane. However, the protruding portions 135 may be partially formed when viewed along the circumference of the conductor 130. Further, a plurality of the protruding portions 135 may be formed so as to be separated from each other in the circumferential direction of the conductor 130. When a plurality of the protruding portions 135 are formed when viewed along the circumference of the conductor 130, it is preferable that the plurality of protruding portions 135 are arranged in point symmetry about the center axis CA. The effect of reducing thermal deformation of the conductor 130 can be obtained in a balanced manner along the circumference.

In the example illustrated in FIG. 4, the contour shape of the protruding portion 135 is circular when viewed from the cross-section of the conductor 130 cut along the direction orthogonal to the Z-direction. The contour shape of the cross-section of the core portion 134 is also circular, and the entire core portion 134 may be substantially cylindrical. Thus, in the present embodiment, the contour shape of the protruding portion 135 and the contour shape of the cross-section of the core portion 134 may be the same shape, or for example, a similar shape, when viewed from the cross-section of the conductor 130 cut along the direction orthogonal to the Z-direction. Note that the contour shape of the protruding portion 135 and the contour shape of the cross-section of the core portion 134 are optional and may be different as described later.

As long as the thermal deformation of the conductor 130 in the direction in which the first main surface 10a and the second main surface 10b face each other (Z-direction) can be reduced, the size of the protruding portion 135 is not particularly limited. However, it is preferable that the height d (FIG. 3) of the protruding portion 135, that is, the length extending in the direction orthogonal to the Z-direction (the direction along the X-Y plane), is longer than the average particle size of the metallic magnetic particles contained in the base body 10. When the conductor 130 is about to expand or contract, the protruding portion 135 exerts a force on the base body 10 on its upper side or lower side from below or above, but if the protruding portion 135 has the height d described above, it is possible to secure a sufficient distance so as not to be overcome by such force. Thus, the function of reducing the thermal deformation of the conductor 130 in the vertical direction can be improved. Note that the height d of the protruding portion 135 can be a protruding distance of the protruding portion 135 as seen in a cross-section of the conductor 130 cut so as to include the center axis CA.

As illustrated in FIG. 3, the shape of the protruding portion 135 may be a shape in which the length (width) in the Z-direction becomes shorter as the distance from the center axis CA of the conductor 130 increases, for example, a substantially triangular shape, as viewed from a cross-section cut along the Z-direction including the center axis. Such a shape is preferable in that the height d of the protruding portion 135 can be increased with a smaller volume. The shape of the protruding portion 135 is not limited, and may be, for example, a polygon including a quadrangle such as a rectangle, a trapezoid, a parallelogram, or the like, or a semicircle or a semi-ellipse. When the cross-sectional shape of the protruding portion 135 cut along the Z-direction is a polygon, the corners may be rounded. Further, the top of the protruding portion 135, that is, the top of the portion protruding in the direction orthogonal to the Z-direction or the direction along the X-Y plane, may be flat or pointed. When a plurality of the protruding portions 135 are formed in one conductor 130, they may have different shapes depending on the location.

The height d of the protruding portion 135 is preferably 5 μm or more and 100 μm or less, more preferably 10 μm or more and 80 μm or less. When the height d is 5 μm or more, the strength or rigidity of the portion of the base body 10 that enters the upper and lower sides of the protruding portion 135 increases, and the effect of reducing thermal deformation of the conductor 130 in the vertical direction can be improved. When the height d is 100 μm or less, the shape of the circumferential surface of the conductor 130 becomes complicated, and the electrical distance between adjacent conductors can be secured to prevent problems such as short circuits. When a plurality of protruding portions 135 are formed and the height of each protruding portion 135 is different, the height d of the protruding portion 135 is an average value.

The height d of the protruding portion 135 is preferably defined as follows in relation to the size of the metallic magnetic particles contained in the base body 10. FIG. 5 schematically illustrates an enlarged view of the portion A of FIG. 3. As illustrated in FIG. 5, if at least one of the upper and lower sides of the protruding portion 135 is closely packed with metallic magnetic particles MP (indicated by dotted lines), and the metallic magnetic particles MP are arranged in at least 3 stages in the direction along the X-Y plane forming a lump of particles, it is considered that sufficient strength against thermal deformation of the conductor 130 is ensured. Therefore, it is preferable that the height d of the protruding portion 135 is height d>5.46r, where the average particle size (radius) of the metallic magnetic particles is r. The specific numerical range of the height d of the protruding portion 135 is set in consideration of the preferred average particle size of the metallic magnetic particles in the present embodiment.

Further, the width w of the protruding portion 135, more specifically, the length of the protruding portion 135 in the Z-direction, may preferably be 5 μm or more and 50 μm or less, and more preferably 10 μm or more and 30 μm or less. If the width w is within the above range, the protruding portion 135 can surely bite into the base body 10, and the effect of reducing thermal deformation of the conductor 130 in the vertical direction can be improved. The width w of the protruding portion 135 can be a distance in the Z-direction from the start point to the end point of the protruding portion 135 in the Z-direction when viewed from a cross-section cut to include the center axis CA of the conductor 130. Both the start point and the end point of the protruding portion 135 are points where the tangent inclination of the contour of the protruding portion 135 becomes 0 on the side close to the center axis CA. However, in the case of the protruding portion 135 formed at the end of the conductor 130, the start point or the end point of the protruding portion 135 may be the position of the end face of the conductor 130. When the plurality of protruding portions 135 are formed and the width of each protruding portion 135 is different, the width w of the protruding portion 135 is an average value.

The circle equivalent size (the size of a circle having the same area) of the cross-section of the core portion 134 of the conductor 130 (the cross-section taken in the direction perpendicular to the center axis CA) may be 30 μm or more and 200 μm or less. The electrical characteristics of the conductor 130 including the DC resistance of the conductor 130 can be regulated by the size of the cross-section of the core portion 134.

### Second Embodiment

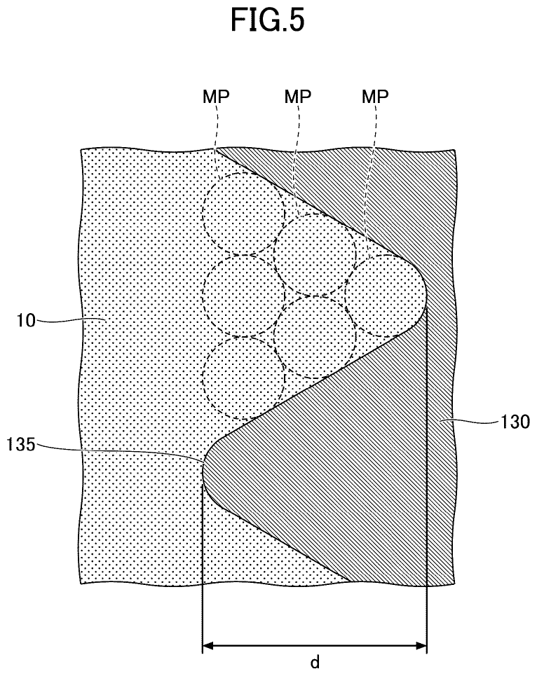

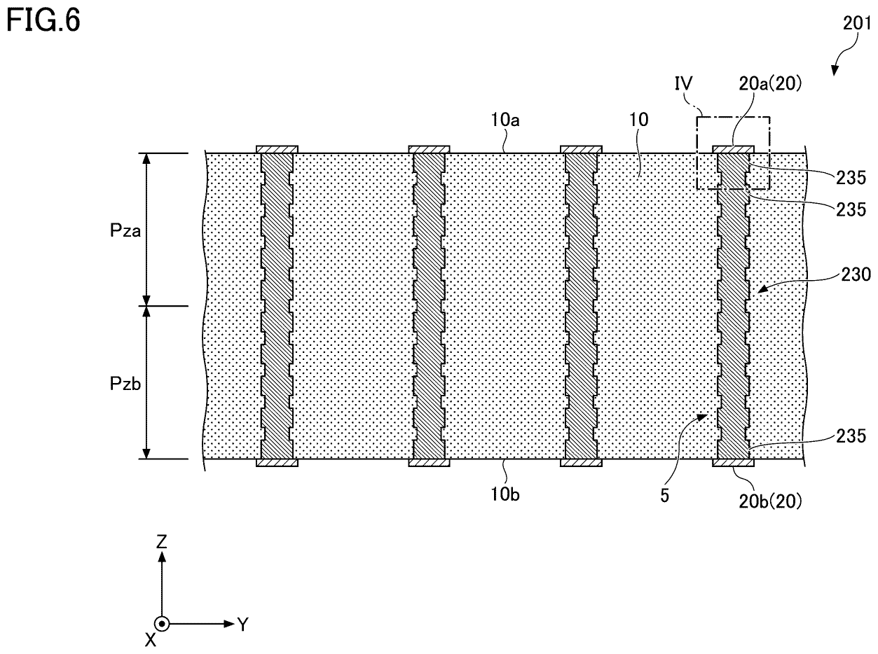

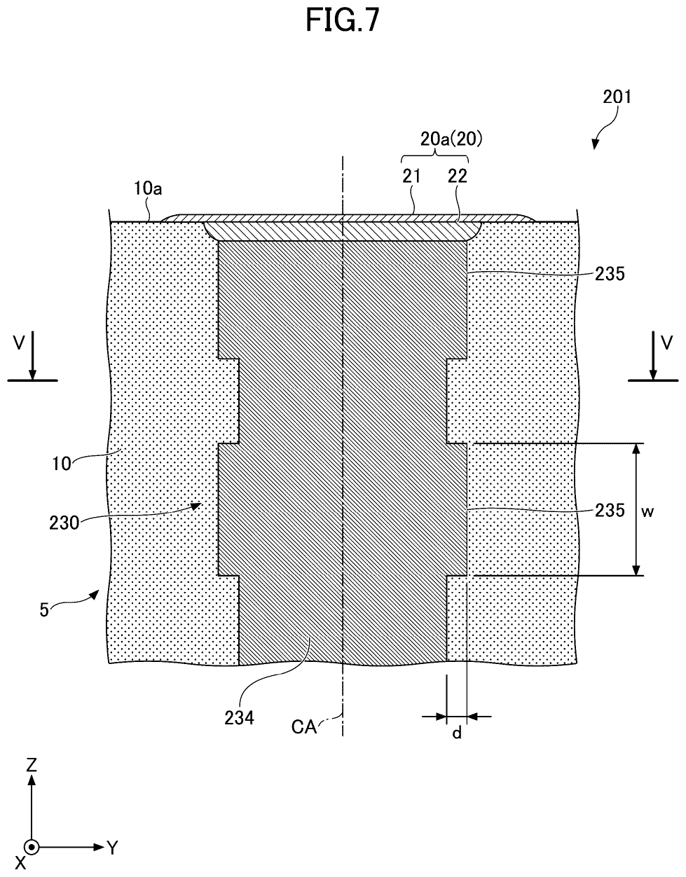

Next, the second embodiment will be described with reference to FIGS. 6 and 7. The coil component 201 according to the second embodiment differs from the coil component 1 according to the first embodiment in that the configuration of the conductor is different. The configuration other than this is the same as that of the first embodiment, and therefore a description thereof is omitted. The definitions of terms and the like are also as described in the first embodiment. FIG. 6 is a partial enlarged view of the I-I cross-section of FIG. 1 in the case of a coil component 201 according to the second embodiment. FIG. 7 is an enlarged view of the portion IV of FIG. 2. FIG. 8 is a cross-sectional view along the line V-V of FIG. 7.

The coil component 201 has the base body 10, two external electrodes 20 each provided on one of the mutually opposite surfaces of the base body 10, and a conductor 230 connected to the two external electrodes 20 and extending inside the base body 10. In the present embodiment also, as illustrated in FIG. 6, four conductors 230 are formed in the coil component 201, and four inductor elements 5 formed by the base body 10, the pair of external electrodes, and the conductor 230, are formed.

Similarly to the first embodiment, in the second embodiment, the conductor 230 is arranged from the first external electrode 20a arranged on the first main surface 10a toward the second external electrode 20b arranged on the second main surface 10b, or from the second external electrode 20b arranged on the second main surface 10b toward the first external electrode 20a arranged on the first main surface 10a. That is, the conductor 230 extends along the opposing direction (Z-direction) in which the first main surface 10a and the second main surface 10b face each other. Because the overall appearance of the coil component 201 is the same as that of the coil component 1 according to the first embodiment, the perspective view of the coil component 201 is omitted.

Further, the conductor 230 has a protruding portion 235 formed on the surface in contact with the base body 10. Also in the second embodiment, a plurality of protruding portions 235 are formed along the Z-direction, but as illustrated in FIG. 7, the size and shape of each protruding portion 235 and the pitch of the protruding portions 235 in the Z-direction are uniform. Further, the shape of the protruding portion 235 is rectangular when viewed from a cross-section along the Z-direction including the central axis CA.

Also in the coil component 201 according to the second embodiment, because the protruding portions 235 are formed on the conductor 230, the protruding portions 235 can bite into the base body 10 along the direction orthogonal to the opposing direction (Z-direction), and the base body 10 can enter the upper and/or lower sides of the protruding portion 235. Thus, as described in the first embodiment, the thermal deformation of the entire conductor 230 including the protruding portions 235 can be reduced in the vertical direction, that is, in the opposing direction (Z-direction). Therefore, it is possible to reduce the possibility of damage caused by the thermal deformation to the periphery of the end of the conductor 230, for example, to the external electrode 20 or the wiring connected to the external electrode 20.

Further, it is preferable that the height d of the protruding portion 235, that is, the length extending in the direction orthogonal to the Z-direction, that is, the direction along the X-Y plane, is longer than the average particle size of the metallic magnetic particles contained in the base body 10. Accordingly, a sufficient length can be secured for the protruding portion 235 so as not to be overcome by the force exerted on the base body 10 in the vertical direction when the protruding portion 235 is about to expand or contract, and the function of reducing the thermal deformation in the vertical direction of the conductor 230 can be improved. The height d of the protruding portion 235 can be an average value of the heights of the plurality of protruding portions. The specific range of the height d of the protruding portion 235 of the second embodiment may be the same as the height d of the protruding portion 135 of the first embodiment.

In the example illustrated in FIG. 8, when viewed from a cross-section cut along the direction orthogonal to the Z-direction (along the X-Y plane), the contour shape of the cross-section of the protruding portion 235 of the conductor 230 is substantially square, more specifically, square with rounded corners. The cross-section of a core portion 234 is similarly square with rounded corners. Thus, the contour shape of the cross-section of the protruding portion 235 and the cross-section of the core portion 234 may be the same or similar.

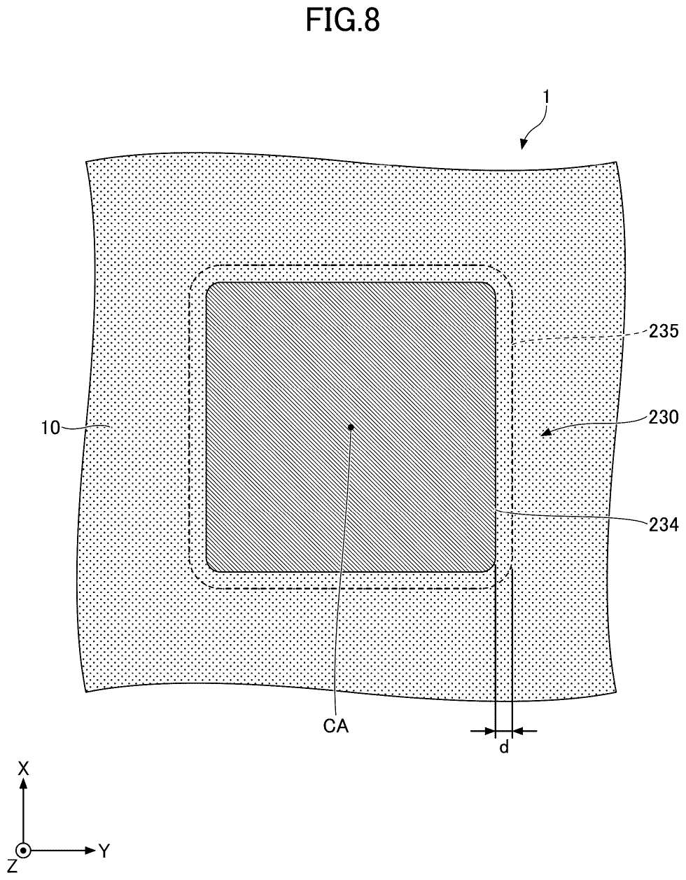

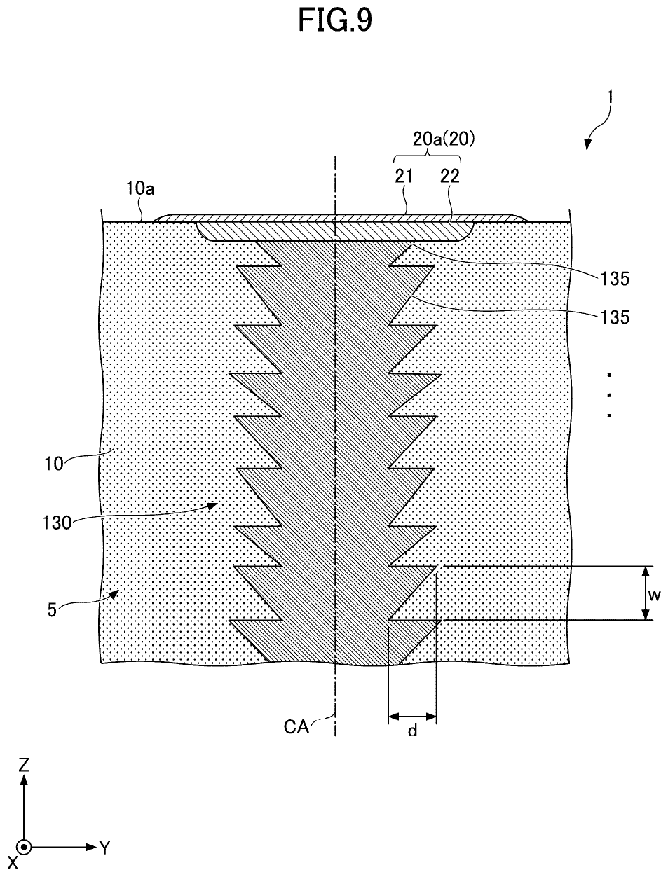

FIGS. 9 to 10B illustrate a modified example of the conductor 130 in the present embodiment as a modified example of the first embodiment. FIG. 9 is a cross-sectional view along the Z-direction at a position including the center axis CA of the conductor 130, and corresponds to FIG. 3. As illustrated in FIG. 9, in a cross-sectional view along the Z-direction including the center axis CA, the upper contour of the protruding portion 135 extends along the Y-direction, and the lower contour of the protruding portion 135 extends at an angle along the Y-direction. Thus, the protruding portions 135 have a substantially triangular cross-sectional shape. Further, the plurality of protruding portions 135 are formed so that there is no space between them, that is, the end point of one protruding portion 135 and the start point of the protruding portion 135 adjacent to the one protruding portion are in contact with each other. By such arrangement of the protruding portions 135, the base body 10 which enters between the protruding portions 135 can be made to have the same size and shape as the protruding portions 135 when viewed from a cross-section cut along the Z-direction, that is, the base body 10 which enters between the protruding portions 135 also has a substantially triangular shape. Thus, the base body 10 can firmly fix the protruding portions 135 of the conductor 130 in the vertical direction (Z-direction), and the function of reducing the thermal deformation of the conductor 130 in the vertical direction (Z-direction) is improved.

FIGS. 10A and 10B are cross-sectional views of the conductor 130 along the direction orthogonal to the Z-direction (direction along the X-Y plane), and corresponds to FIG. 4. As illustrated in FIG. 10A, the cross-sectional shape of the core portion 134 is circular, but the contour shape of the protruding portion 135 may be substantially square, more specifically, a square in which the corners of each vertex are rounded. Also, as illustrated in FIG. 10B, the cross-sectional shape of the core portion 134 is circular, but the contour shape of the protruding portions 135 may be substantially triangular, or more specifically, triangular with the corners of each vertex being arcuate. In the configuration illustrated in FIGS. 10A and 10B viewed along the circumference, the height of the protruding portion 135 varies depending on the location, and has a maximum height value dmax and a minimum height value dmin.

<Substrate with Built-In Coil Component>

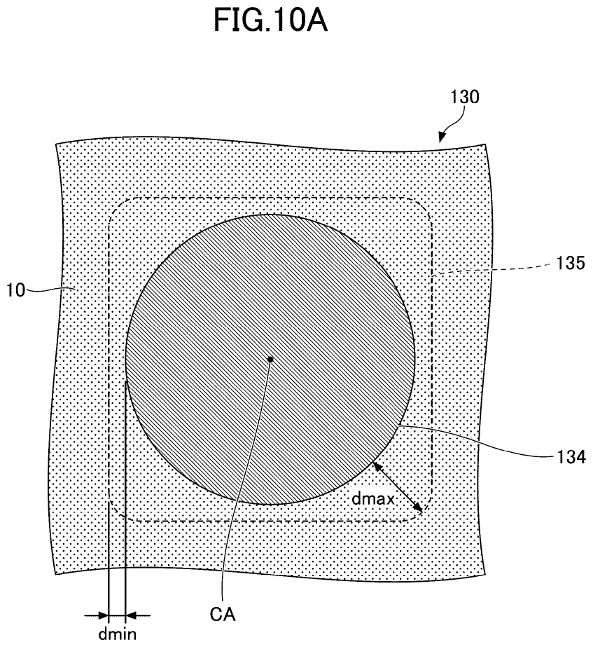

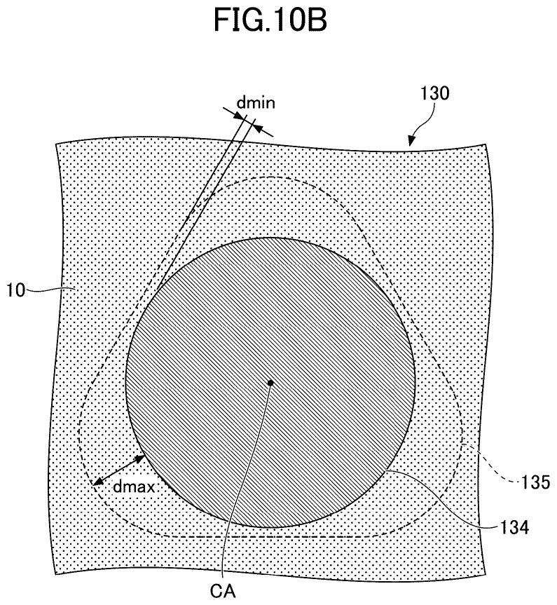

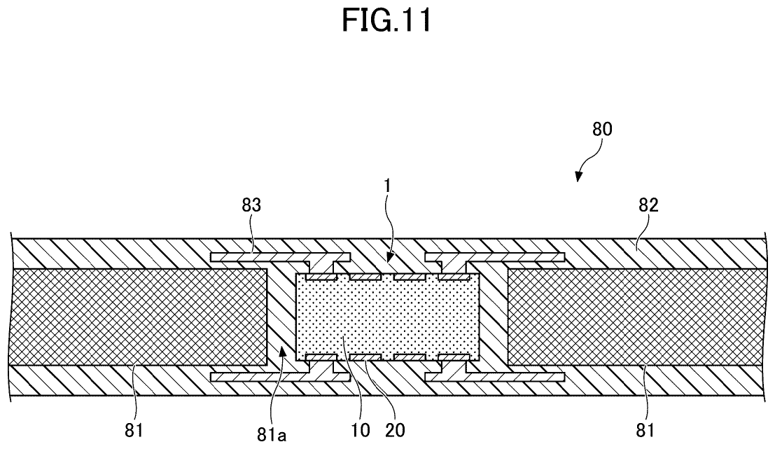

The coil component 1 or the coil component 201 described above can be provided as a wiring substrate with built-in components (also referred to as a substrate with built-in coil components). FIG. 11 illustrates, as an example, a schematic diagram of a substrate 80 with the built-in coil component 1. The substrate 80 with the built-in coil component can be formed by, for example, arranging the coil component 1 in a through-hole 81a formed in a substrate 81, sealing the coil component 1 with resin, irradiating the external electrode 20 with laser to form a via hole, exposing the external electrode 20, and applying plating treatment to the via hole, thereby connecting the wiring 83 to the external electrode 20 of the coil component 1, and sealing the coil component 1 with a sealing resin 82 on the first main surface 10a side and the second main surface 10b side.

Such a substrate 80 with the built-in coil component has the advantage of being more compact than a wiring substrate with components mounted on the main surface of the substrate, because elements can be arranged three-dimensionally including the thickness direction. Further, because the length of the connected wiring can be shortened, power distribution loss can be reduced, and the substrate 80 can contribute to power saving of the electronic equipment in which the coil components are mounted. However, because elements such as the CPU and the coil components are arranged closer to each other, it is necessary to have a structure with higher accuracy and less waste. Further, because the distance of the coil components from the elements such as the CPU becomes shorter, they are affected by heat from the elements and exposed to temperature changes, and a structure capable of reducing thermal deformation of the conductors due to temperature changes is required. Therefore, the embodiment of the present disclosure (including the first and second embodiments) is suitably used in a wiring substrate with built-in coil components.

### <Method of Manufacturing Coil Component>

The method of manufacturing a coil component according to an embodiment of the present disclosure is not particularly limited, and a known manufacturing process of coil components such as a lamination process or a thin film process can be used. A method of manufacturing coil components by a lamination process will be described below as a representative example.

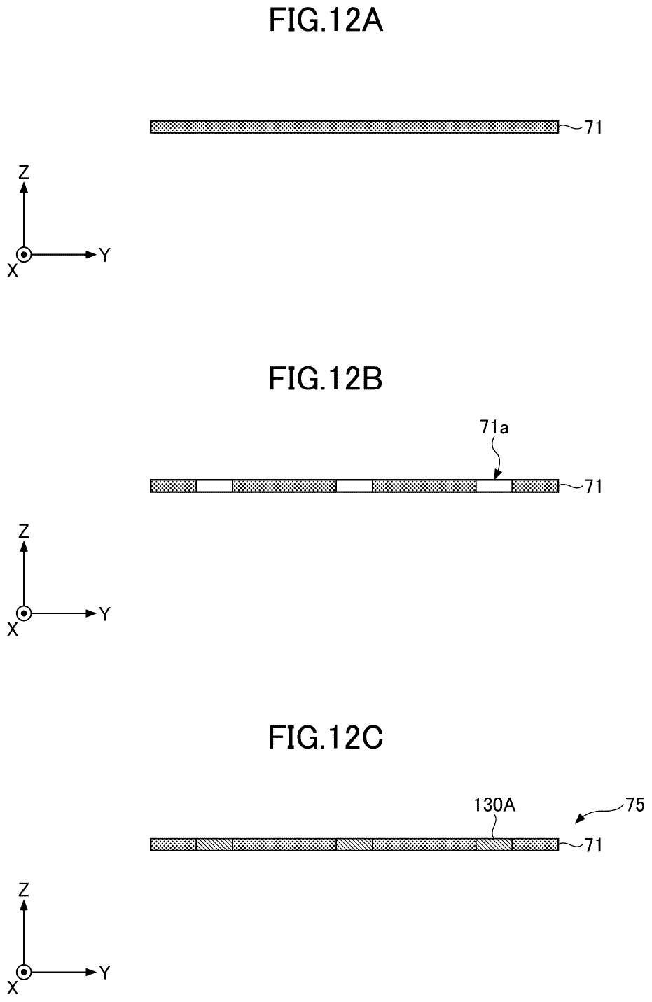

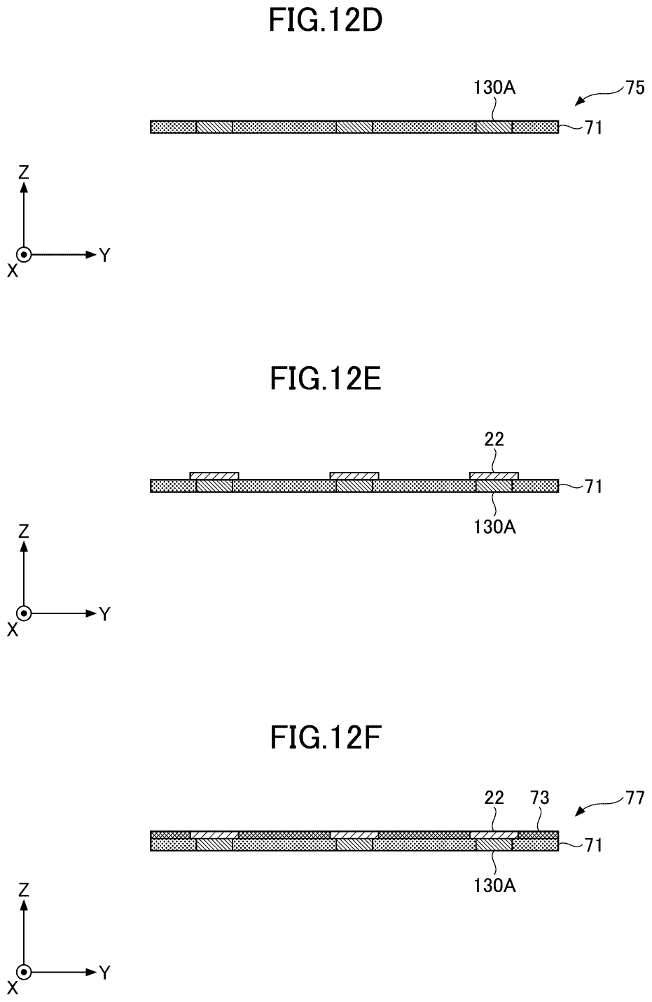

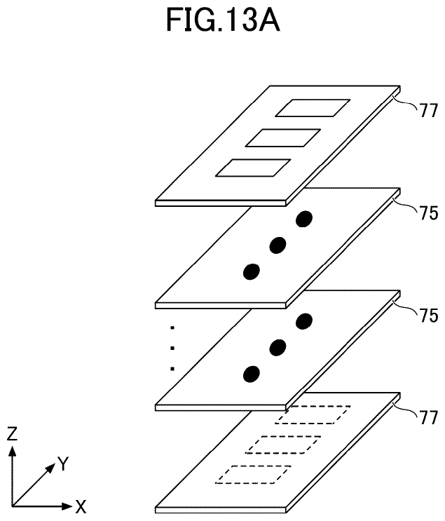

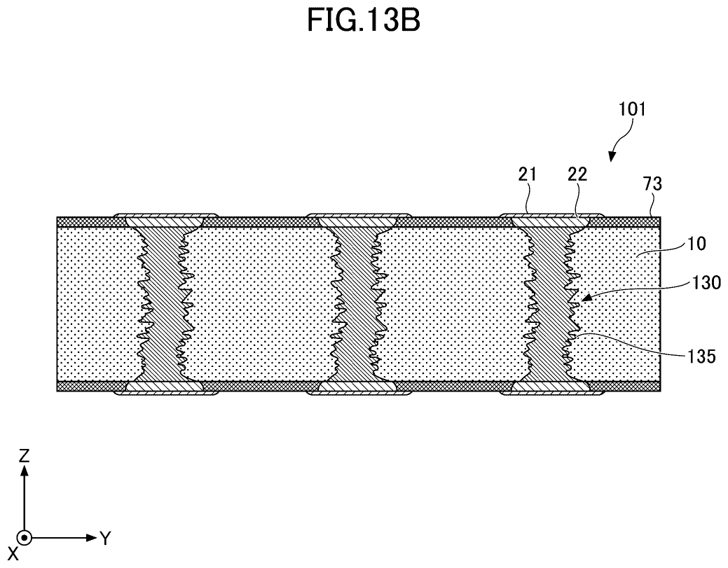

FIGS. 12A to 13B illustrate a manufacturing method using a lamination process. The lamination process is suitable, for example, as a method for manufacturing the coil component 1 according to the first embodiment. In the lamination process, first, a magnetic sheet 71 which is a precursor of the base body forming sheet constituting the base body 10 is produced (FIG. 12A). The magnetic sheet 71 is obtained, for example, by kneading a metallic magnetic material with a resin, producing a slurry, applying the slurry to a plastic base film by a method such as a doctor blade method, drying the slurry, and cutting it to a predetermined size.

Next, a through-hole 71a is formed at a predetermined position of the magnetic sheet 71 to penetrate the magnetic sheet 71 in the thickness direction (FIG. 12B), and the conductive paste 130A is embedded in the through-hole 71a formed in the magnetic sheet by printing the conductive paste on the upper surface of the magnetic sheet in which the through-hole 71a is formed by a method such as a screen printing method, thereby producing a body forming sheet 75 (FIG. 12C). At this time, by changing the size and/or shape of the through-hole 71a formed in the body forming sheets 75, a plurality of body forming sheets 75 having different sizes and/or shapes in the conductive paste (conductor forming material) 130A are formed. The size and/or shape of the through-hole 71a formed in the plurality of body forming sheets 75 are designed such that, when the plurality of body forming sheets 75 are laminated (FIG. 13A), protruding portions 135 (FIG. 13B) protruding in the direction orthogonal to the Z-direction are formed in the conductor 130.

On the other hand, as illustrated in FIGS. 12D to 12F, an outermost portion forming sheet 77 for forming the outermost portion including the external electrode 20 is produced. For the body forming sheet 75 (FIG. 12C) obtained in FIGS. 12A to 12C, a second portion 22 of the external electrode 20 is formed by screen printing or the like using conductive paste (FIG. 12E). Further, an insulating layer 73 is formed between the second portions 22 so as to be flush with the second portions 22, by screen printing or the like using insulating paste to form the outermost portion forming sheet 77 (FIG. 12F).

A plurality of the obtained body forming sheets 75 are laminated in the Z-direction of the coil component 201 to be obtained, and the outermost portion forming sheets 77 are laminated on the uppermost and lowermost sides in the Z-direction, respectively (FIG. 13A). The obtained laminate may be thermally compressed by a press machine. Next, by using a cutting machine such as a dicing machine, the laminate is diced into individual pieces of a desired size to obtain individual pieces of the laminate. The individual pieces of the laminate may be subjected to polishing treatment such as barrel polishing, if necessary.

Next, the individual pieces of the laminate are defatted and heated to obtain the base body 10. By this heating treatment, an oxide layer is formed on the surface of each soft magnetic metal particles contained in the magnetic sheet, and adjacent soft magnetic metal particles are bonded through the oxide layer. The heat treatment of the chip laminate is carried out at a heating temperature of 600° C. to 800° C., for example, for a heating time of 20 minutes to 120 minutes.

Next, the first portion 21 of the external electrode 20 is formed by plating or the like to obtain the coil component 201 (FIG. 13B).

The above-described laminating process is a method of laminating, in the Z-direction, sheets having a main surface along the X-Y plane of the coil component, but the coil component can also be manufactured by laminating, in the X-direction, sheets having the main surface along the Y-Z plane of the coil component, or by laminating, in the Y-direction, sheets having the main surface along the X-Z plane of the coil component. Although the thin-film process is described as a suitable example for manufacturing the coil component 201 according to the second embodiment and the laminating process is described as a suitable example for manufacturing the coil component 201 according to the first embodiment, the laminating process may be used for manufacturing the coil component 201 or the thin-film process for manufacturing the coil component 1.

The thin film process is suitable, for example, as a method for manufacturing the coil component 1 according to the first embodiment. In the thin film process, a positive resist obtained by developing a photoresist is subjected to plating treatment using a conductor material, and then the positive resist is removed to form a plurality of conductors having predetermined protruding portions according to the present embodiment. The conductors thus obtained are embedded in a based body material, and after being diced into individual pieces, degreased, and heated, external electrodes are formed by plating treatment to obtain a coil components.

Although specific embodiments have been described in detail above, the present disclosure is not limited to the above embodiments. The above embodiments can be changed, modified, replaced, added, deleted, and combined in various ways within the scope of the claims.

Examples of the present disclosure are as follows.

1> A coil component including:
a base body made of a magnetic material;
two external electrodes respectively provided on surfaces of the base body that are facing each other; and
a conductor connected to each of the two external electrodes and directed from one of the external electrodes to another one of the external electrodes in the base body, wherein
the conductor includes a protruding portion on a surface in contact with the base body.

<2> The coil component according to <1>, wherein
the conductor is bisected into an upper portion and a lower portion along a direction facing the two external electrodes,
the conductor includes two or more of the protruding portions, and
at least one of the protruding portions is formed in the upper portion and at least one of the protruding portions is formed in the lower portion.

<3> The coil component according to <1> or <2>, wherein
the base body includes metallic magnetic particles, and
when viewed in a cross-section cut along a direction in which the surfaces of the base body face each other, a size of the protruding portion protruding in a direction orthogonal to the direction in which the surfaces of the base body face each other, is larger than an average particle size of each of the metallic magnetic particles.

<4> The coil component according to any of <1> to <3>, wherein when viewed in a direction toward the surface of the base body on which the external electrode is provided, the conductor is provided within a range corresponding to the external electrode.

<5> The coil component according to any of <1> to <4>, wherein the external electrode is directly connected to the protruding portion.

<6> The coil component according to <1> or <2>, wherein the coil component is a component embedded in a substrate.

What is claimed is:

1. A coil component comprising:
a base body made of a magnetic material;
two external electrodes respectively provided on surfaces of the base body that are facing each other; and
a conductor connected to each of the two external electrodes and directed from one of the external electrodes to another one of the external electrodes in the base body, wherein
the conductor includes a protruding portion on a surface in contact with the base body.

2. The coil component according to claim 1, wherein
the conductor is bisected into an upper portion and a lower portion along a direction facing the two external electrodes,
the conductor includes two or more of the protruding portions, and
at least one of the protruding portions is formed in the upper portion and at least one of the protruding portions is formed in the lower portion.

3. The coil component according to claim 1, wherein
the base body includes metallic magnetic particles, and
when viewed in a cross-section cut along a direction in which the surfaces of the base body face each other, a size of the protruding portion protruding in a direction orthogonal to the direction in which the surfaces of the base body face each other, is larger than an average particle size of each of the metallic magnetic particles.

4. The coil component according to claim 1, wherein when viewed in a direction toward the surface of the base body on which the external electrode is provided, the conductor is provided within a range corresponding to the external electrode.

5. The coil component according to claim 1, wherein the external electrode is directly connected to the protruding portion.

6. The coil component according to claim 1, wherein the coil component is a component embedded in a substrate.
